(19) United States
(12) Patent Application Publication
(10) Pub. No.: US 2009/0229079 A1
(43) Pub. Date: Sep. 17, 2009

(54) HINGE REINFORCED STRUCTURE

(75) Inventor: Ting-Hung SU, Taipei County (TW)

Correspondence Address: Muncy, Geissler, Olds & Lowe, PLLC, P.O. BOX 1364, FAIRFAX, VA, 22038-1364, US

(73) Assignee: Sinher Technology Inc.

(21) Appl. No.: 12/049,812

(22) Filed: Mar. 17, 2008

(51) Int. Cl. E05D 11/02; E05D 11/10

(52) U.S. Cl. 16/274; 16/351

(57) ABSTRACT

A hinge reinforced structure to improve wobbling and idle swiveling of conventional hinges that result in unsteadiness includes mainly a rotary element and a holding element. The rotary element has a pintle coupled with a pintle hole formed on the holding element to generate a swivel displacement. The pintle has a driving portion to form a gap with the pintle hole. The pintle further is coupled with a reinforced element which has at least one reinforced portion to wedge in the gap and press the inner wall of the pintle hole to provide a bracing torque thereby to enhance the steadiness of the structure.

### FIELD OF THE INVENTION

The present invention relates to a hinge reinforced structure and particularly to a hinge reinforced structure to couple two articles and allow them to swivel relative to each other.

### BACKGROUND OF THE INVENTION

Many electronic devices such as notebook computers, mobile phones and the like now on the market have a display screen coupling with a host through a hinge. When in use the display device can be flipped against the host for operation. When not in use the display device can be folded over the host. Through the hinge the size of the electronic device can be shrunk to facilitate storing and carrying.

For instance, R.O.C. patent No. M326329 entitled “Hinge structure” mainly includes a hinge seat, a pintle, an elastic element and a bucking plate. The pintle is pivotally held on the hinge seat and coupled with the elastic element. The bucking plate has a coupling hole to be coupled on the pintle between the elastic element and the hinge seat to provide anchoring effect when the pintle rotates to reduce wearing of the elastic element and enhance durability of the hinge and improve practicality. Applicant also has a patent granted in R.O.C. by patent No. M253818 entitled “Hinge for anchoring and closing on small pintles” which has a pintle with one end coupled with a fastening seat and the other end coupled with a holding seat. The one end of the pintle coupled with the fastening seat also has a regulation structure and a resistant force generation structure that are interposed by a return element to form a stageless return hinge. The regulation structure has a rotary element and an anchor element that form a contact surface with a swiveling displacement formed thereon. Only one fixed spot is provided to allow the rotary element and the anchor element to latch with each other to form a folding and closed condition. The resistant force generation structure includes a plurality of resistant elements and washers to increase frictional forces between them.

Although both techniques mentioned above can increase the durability or frictional resistance of the hinge, they have one common drawback, namely the pintle of the general hinge is usually formed in a non-circular strut to mate non-circular holes formed on the washers and the like. Through the non-circular washers and pintle a frictional resistant force is generated while the pintle rotates and an anchor effect is produced. Such a structure creates gaps between the coupling pintle hole and the pintle. Hence wobbling is generated on the pintle and fastening seat. Moreover, the pintle has to rotate an idle swivel displacement before pressing the inner wall of the pintle hole to drive the washers to swivel. Such a structure is not steady and creates problems in practice.

### SUMMARY OF THE INVENTION

The primary object of the present invention is to solve the aforesaid problems and increase steadiness of a hinge.

To achieve the foregoing object, the present invention provides a hinge which mainly has a rotary element and a holding element. The rotary element has a pintle to be coupled with a pintle hole formed on the holding element. The rotary element can generate a rotational displacement relative the holding element, and has a driving portion to form a gap with the pintle hole. The pintle further is coupled with a reinforced element which has at least one reinforced portion wedged in the gap to press against an inner wall of the pintle hole.

The reinforced element can provide a frictional force for the relative rotation of the rotary element and the holding element, also has the reinforced portion pressing the inner wall of the pintle hole and filling the gap between the driving portion and the pintle hole. Such a structure provides benefits not available on the conventional techniques, notably:

1. Wobbling of the rotary element and the holding element can be prevented to enhance steadiness of the hinge.

2. When the rotary element rotates the pintle does not have to press on the inner wall of the pintle hole first. With the reinforced element pressing the inner wall of the pintle hole, swiveling of the rotary element is smoother.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the invention.

FIG. 2 is a sectional view of the invention

FIG. 3 is an exploded view of another embodiment of the invention.

FIG. 4 is a schematic view of an embodiment of the invention.

FIG. 5 is a schematic view of another embodiment of the invention.

### DETAILED DESCRIPTION OF THE PREFERRED EMBODIMENTS

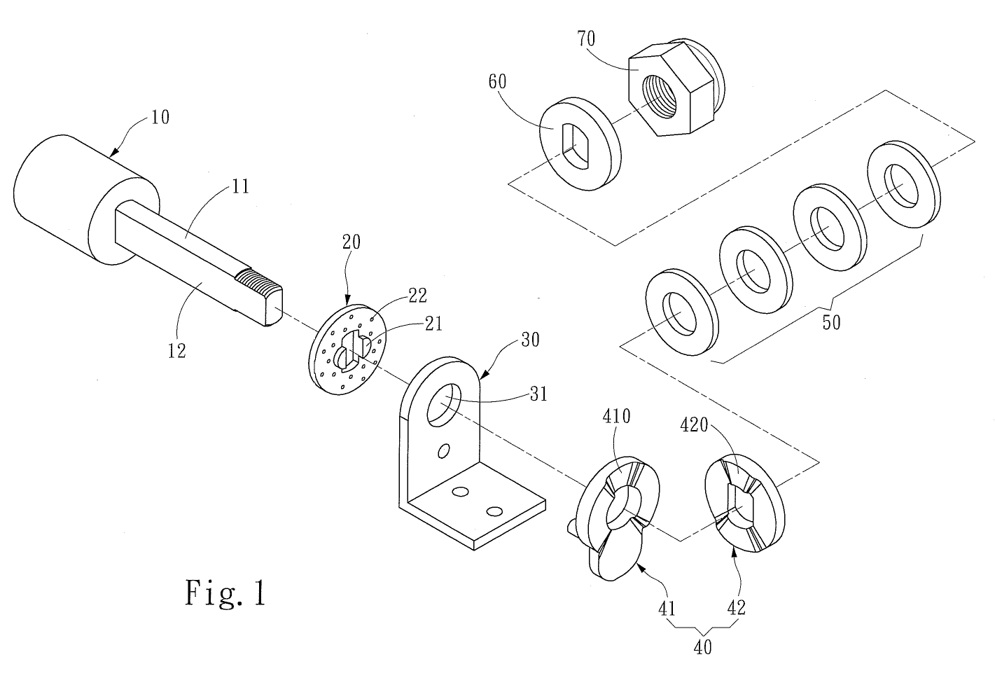

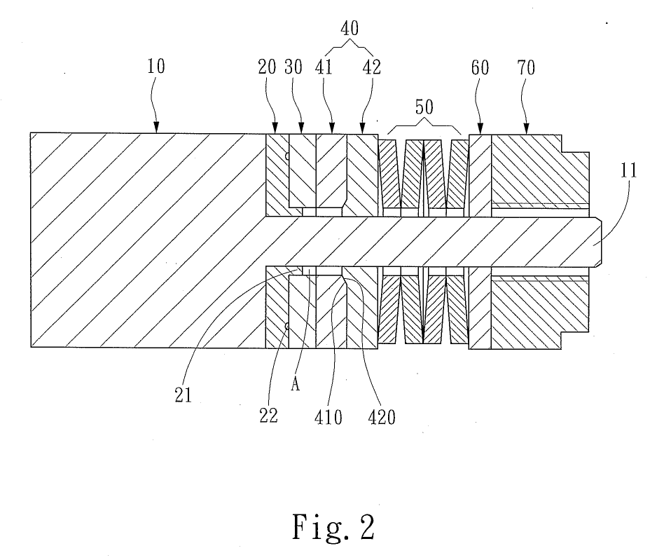

Please refer to FIGS. 1 and 2, the hinge reinforced structure according to the invention mainly includes a rotary element 10 and a holding element 30. The rotary element 10 has a pintle 11 to be coupled with a pintle hole 31 formed on the holding element 30 to generate a rotational displacement relative to the holding element 30. The pintle 11 has a driving portion 12 to form a gap A with the pintle hole 31. The hinge further has an anchor mechanism 40 and a return mechanism 50 run through by the pintle 11. The pintle 11 has a distal end coupled with a washer 60 and a nut 70 to confine the anchor mechanism 40 and the return mechanism 50 on the pintle 11. Referring to the drawings, the anchor mechanism 40 includes a jutting element 41 fastened to one side of the holding element 30 and an indented element 42 engaged with the jutting element 41 and driven by the pintle 11 to rotate synchronously therewith. The jutting element 41 and the indented element 42 have respectively an anchor boss 410 and an anchor recess 420 on a contact surface formed between them. The anchor boss 410 and anchor recess 420 are latchable with each other to form anchoring of the indented element 42 and jutting element 41. The return mechanism 50 includes a plurality of disk-like washers to provide a latching torque for the anchor boss 410 and the anchor recess 420. It is to be noted that the anchor mechanism 40 and the return mechanism 50 shown in the drawings serve merely for illustrative purpose, and are not the limitation of the invention. The pintle 11 further has a reinforced element 20 located thereon. The reinforced element 20 has at least one reinforced portion 21 to wedge in the gap A and press the inner wall of the pintle hole 31. Thereby bracing force of the pintle 11 in the pintle hole 31 can be increased so that the rotary element 10 does not wobble in the pintle hole 31 because of the gap A. And initial idle rotation of the rotary element 10 that might otherwise occur can also be eliminated to enhance the steadiness of the whole structure.

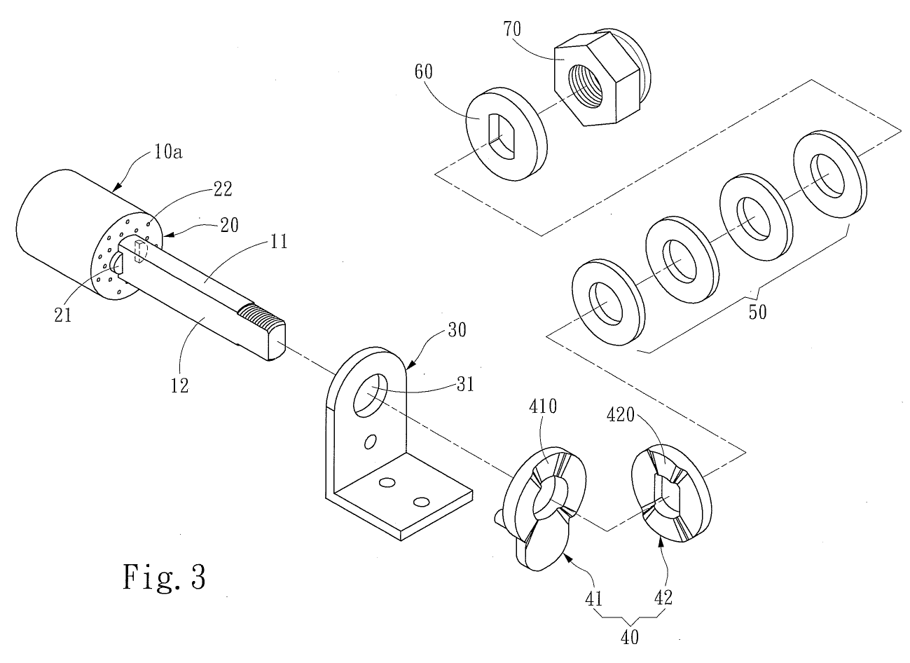

The reinforced element 20 is a washer and has a plurality of lube oil cavities 22 to improve rotation smoothness of the rotary element 10 relative to the holding element 30. In addition, the reinforced element 20 may also be integrally formed with the rotary element 10a as shown in FIG. 3. Then the pintle 11 can be directly inserted into the pintle hole 331 with the reinforced portion 21 on the driving portion 12 pressing the inner wall of the pintle hole 31.

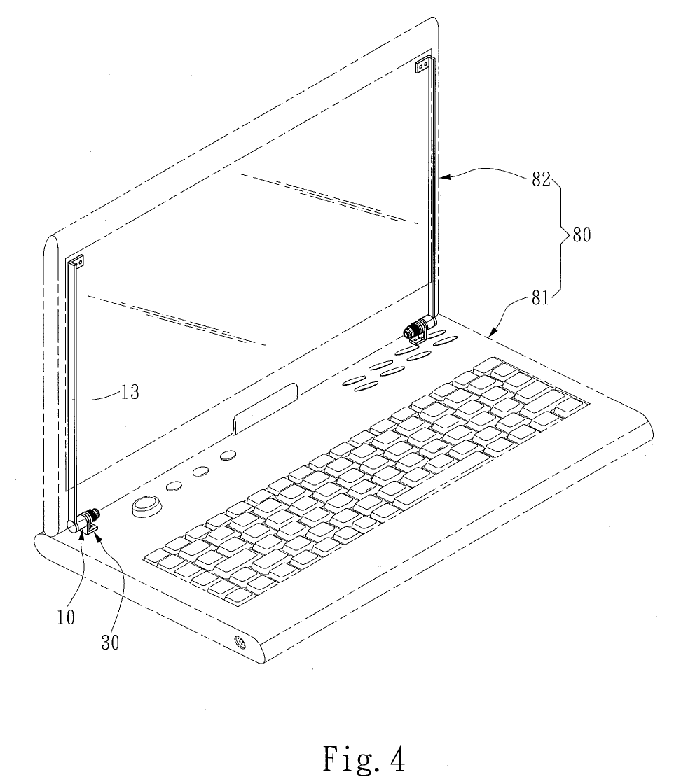

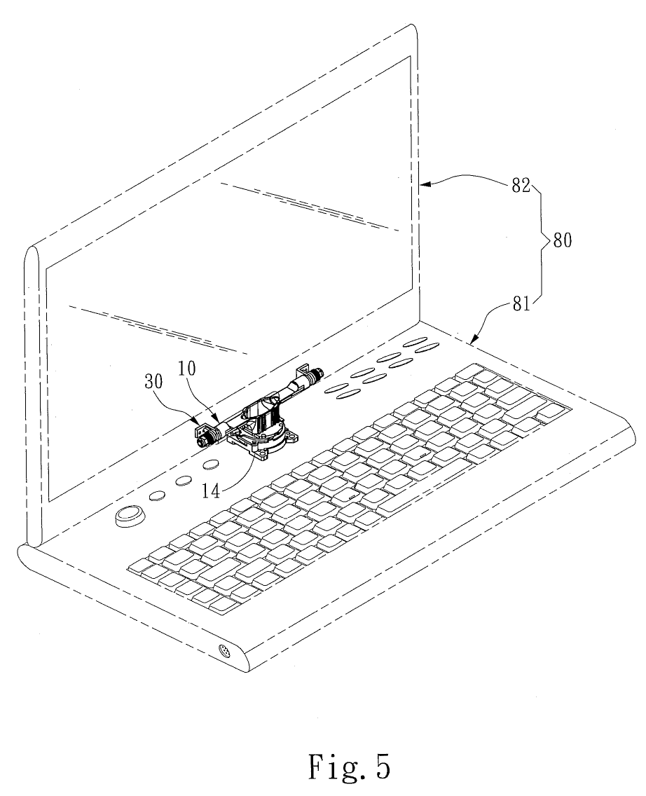

In an embodiment of the invention, referring to FIG. 4, a single hinge is disposed at two sides of a notebook computer 80. The holding element 30 is located on a host 81 of the notebook computer 80. The rotary element 10 is coupled with a bracing arm 13 to be fastened to a display device 82 of the notebook computer 80. Thereby the display device 82 can be flipped relative to the host 81. Moreover, the hinge may also be used as a swivel hinge on the notebook computer 80 as shown in FIG. 5. In such a circumstance the rotary element 11 is mounted onto a swivel dock 14 located on the host 81. The holding element 30 is fastened to the display device 82 so that not only the display device 82 can be flipped against the host 81, it also can be swiveled relative to the host 81. More important, either the single pintle or the swivel hinge can adopt the reinforced element 20 to prevent wobbling of the display device 82 and the host 81. And the display device 82 can be flipped against the host 81 without creating idle swiveling. Thus the structure is steadier and stronger.

As a conclusion, the rotary element 10 in the hinge of the invention has the reinforced element 20 located thereon to be wedged in one side of the pintle hole 31 of the holding element 30. Such a structure not only increases the frictional force during relative swiveling of the rotary element 10 and the holding element 30, by pressing the reinforced portion 21 on the inner wall of the pintle hole 31, the gap A between the driving portion 12 of the pintle 11 and the pintle hole 31 is filled. Compared with the conventional techniques, such a structure provides the following benefits:

1. Wobbling of the rotary element 10 and the holding element 30 that might otherwise occur can be prevented, and steadiness of the hinge improves.

2. As the pintle 11 is not directly in contact with the inner wall of the pintle hole 31 during swiveling, instead, the reinforced element 20 presses the inner wall of the pintle hole 31, swiveling of the rotary element 10 is smoother.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A hinge reinforced structure for a hinge, comprising:
a holding element having a pintlehole;
a rotary element which has a pintle coupling with the pintle hole of the holding element to form a swivel displacement relative to the holding element, the pintle having a driving portion to form a gap with the pintle hole; and
a reinforced element having at least one reinforced portion located on the rotary element to be wedged in the gap to press an inner wall of the pintle hole.

2. The hinge reinforced structure of claim 1, wherein the reinforced element and the rotary element are integrally formed into one body.

3. The hinge reinforced structure of claim 1, wherein the reinforced element has a plurality of lube oil cavities.

4. The hinge reinforced structure of claim 1, wherein the hinge has a single pintle.

5. The hinge reinforced structure of claim 1, wherein the hinge is swivelable.
